(19) United States
(12) Patent Application Publication
(10) Pub. No.: US 2026/0162319 A1
(43) Pub. Date: Jun. 11, 2026

(54) METHOD, APPARATUS, DEVICE AND STORAGE MEDIUM FOR MEDIA CONTENT PROCESSING

(71) Applicants: Lemon Inc., Grand Cayman (KY); Beijing Zitiao Network Technology Co., Ltd., Beijing (CN)

(72) Inventors: Yiding YANG, Los Angeles, CA (US); Bo LIU, Los Angeles, CA (US); Haibin HUANG, Los Angeles, CA (US); Chongyang MA, Culver City, CA (US); Yunzhu LI, Los Angeles, CA (US); Youran WU, Beijing (CN); Chenliang ZHANG, Beijing (CN)

(21) Appl. No.: 19/416,786

(22) Filed: Dec. 11, 2025

(30) Foreign Application Priority Data
Dec. 11, 2024 (CN) 202411822613.3

(51) Int. Cl. G06T 11/00

(52) U.S. Cl. CPC G06T 11/00

(57) ABSTRACT

Embodiments of the disclosure relate method, apparatus, device and storage medium for processing a media content. The method includes: obtaining a first media content; and generating a second media content by applying an effect to the first media content with a model, wherein the model is trained based on the following process: determining a plurality of sub-effects corresponding to the effect; determining a plurality of effect models corresponding to the plurality of sub-effects from a set of pre-trained effect model; generating a plurality of corresponding output images by processing a plurality of sample images with the plurality of effect models according to a preset order; and training the model with the plurality of sample images and the plurality of corresponding output images. According to embodiments of the present disclosure, the generation efficiency of the model can be improved.

### CROSS-REFERENCE

This application claims the benefit of Chinese Patent Application No. 202411822613.3, filed on Dec. 12, 2024, entitled “METHOD, APPARATUS, DEVICE AND STORAGE MEDIUM FOR MEDIA CONTENT PROCESSING,” the entire content of which is incorporated herein by reference.

### FIELD

Example embodiments of the present disclosure generally relate to the field of computers, and in particular, to a method, an apparatus, a device, and a computer-readable storage medium for processing a media content.

### BACKGROUND

With the development of computers, terminal devices such as mobile phones have the capability of processing a media content in real time.

However, the process of generating resources for processing the media content in real time on the terminal device is complex, resulting in few resources for processing the media content in real time. This will affect the user's experience.

### SUMMARY

In a first aspect of the present disclosure, a method of processing a media content is provided. The method comprises: obtaining a first media content; and generating a second media content by applying an effect to the first media content with a model, wherein the model is trained based on the following process: determining a plurality of sub-effects corresponding to the effect; determining a plurality of effect models corresponding to the plurality of sub-effects from the set of pre-trained effect model; generate a plurality of corresponding output images by processing a plurality of sample images with the plurality of effect models according to a preset order ; and training the model with the plurality of sample images and the plurality of corresponding output images.

In a second aspect of the present disclosure, an apparatus for processing a media content is provided. The apparatus comprises an obtaining module configured to obtain a first media content; and a generation module configured to generate a second media content by applying an effect to the first media content with the model, wherein the model is trained based on the following process: determining a plurality of sub-effects corresponding to the effect; determining a plurality of effect models corresponding to the plurality of sub-effects from a set of pre-trained effect model set; generating a plurality of corresponding output images by processing a plurality of sample images with the plurality of effect models according to a preset order; and training the model with the plurality of sample images and the plurality of corresponding output images.

In a third aspect of the present disclosure, an electronic device is provided. The device comprises at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIG. 2A to FIG. 2E illustrate example interfaces in accordance with some embodiments of the present disclosure;

FIG. 3 shows a flowchart of an example process of processing a media content according to some embodiments of the present disclosure;

FIG. 4 is a block diagram of an example process of training a model according to some embodiments of the present disclosure;

FIG. 5 illustrates a flowchart of an example process of training a model according to some embodiments of the present disclosure;

FIG. 6 illustrates a schematic structural block diagram of an example apparatus for processing a media content according to some embodiments of the present disclosure; and

FIG. 7 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for example purposes only and are not intended to limit the scope of the present disclosure.

It should be noted that the title of any section/subsection provided herein is not limiting. Various embodiments are described throughout and any type of embodiments may be included in any section/subsection. Furthermore, embodiments described in any section/subsection may be combined in any manner with the same section/subsection and/or any other embodiment described in different sections/subsections.

In the description of embodiments of the present disclosure, the terms “include” and the like should be understood to be “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, obtaining and/or use of data, and the like. These aspects all follow the corresponding laws and regulations and related regulations. In embodiments of the present disclosure, all data is collected, obtained, processed, processed, forwarded, used, etc., all of which are performed on the premise that the user knows and confirms. Accordingly, when implementing embodiments of the present disclosure, the types of data or information that may be involved, the usage scope, the usage scenario, and the like should be notified to the user and the authorization of the user should be obtained in an appropriate manner according to the relevant laws and regulations. The specific notification and/or authorization manner may vary according to actual situations and application scenarios, and the scope of the present disclosure is not limited in this respect.

According to the solutions in the present specification and embodiments, for example, if the processing of personal information is involved, the processing will be carried out on the premise of a legal basis (for example, obtaining consent from the data subject or necessity to fulfill a contract), and the processing will be carried out within the scope of the stipulations or agreements. The user's refusing to process any personal information beyond what is necessary for the basic functions will not affect their use of those functions.

As mentioned above, the terminal device typically processes the media content using a machine learning model with the ability to process a media content. To meet various usage requirements of a user, the terminal device may deploy a plurality of machine learning models. However, the training process of each machine learning model is complex, and training machine learning model also needs many human resources. This makes the efficiency of generating the machine learning model low, resulting in a limited number of machine learning models provided to the user, which will affect the user's experience.

Embodiments of the present disclosure provide a solution for processing a media content. The solution includes: obtaining a first media content; and generating a second media content by applying an effect to the first media content with a model, where the model is trained based on the following process: determining a plurality of sub-effects corresponding to the effect; determining a plurality of effect models corresponding to the plurality of sub-effects from the set of pre-trained effect model; generating a plurality of corresponding output images by processing a plurality of sample images with the plurality of effect models according to a preset order; and training the model with the plurality of sample images and the plurality of corresponding output images.

In this way, embodiments of the present disclosure can generate training samples for training the model with pre-trained multiple effect models to train and obtain a model. Therefore, human resources required for training the model are reduced, and the generation efficiency of the model is improved to a certain extent.

Various example implementations of this solution are described in detail below in conjunction with the accompanying drawings.

### Example Environment

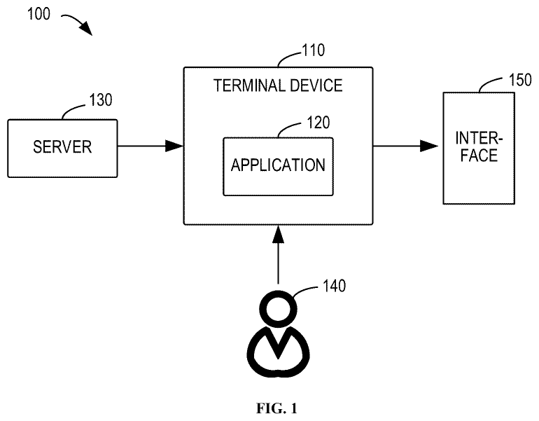

FIG. 1 illustrates a schematic diagram of an example environment 100 in which embodiments of the present disclosure can be implemented. As shown in FIG. 1, the example environment 100 may include a terminal device 110.

In this example environment 100, the terminal device 110 may run an application 120 that supports processing the media content. The application 120 may be any suitable type of application for processing the media content, examples of which may include, but are not limited to, image processing applications, video processing applications, or other suitable applications. The user 140 may interact with the application 120 via the terminal device 110 and/or its attached device.

In the environment 100 of FIG. 1, if the application 120 is in an active state, the terminal device 110 may present an interface 150 for supporting processing the media content through the application 120.

In some embodiments, the terminal device 110 communicates with a server 130 to enable provisioning of services to the application 120. The terminal device 110 may be any type of mobile terminal, a fixed terminal, or a portable terminal, including a mobile phone, a desktop computer, a laptop computer, a notebook computer, a netbook computer, a tablet computer, a media computer, a multimedia tablet, a palmtop computer, a portable game terminal, a virtual reality/argument reality (VR/AR) device, a personal communication system (PCS) device, a personal navigation device, a personal digital assistant (PDA), an audio/video player, a digital camera/camcorder, a positioning device, a television receiver, a radio broadcast receiver, an electronic book device, a game device, or any combination thereof, including accessories and peripherals of these devices, or any combination thereof. In some embodiments, the terminal device 110 can also support any type of interface (such as a “wearable” circuit, etc.) for the user 140.

The server 130 may be a standalone physical server, a server cluster or a distributed system composed of a plurality of physical servers, or may be a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server, such as a mainframe, an edge computing node, a computing device in a cloud environment, or the like. The server 130 may provide a background service for an application 120 that supports processing the media content in the terminal device 110.

A communication connection may be established between the server 130 and the terminal device 110. The communication connection may be established in a wired manner or a wireless manner. The communication connection may include, but is not limited to, a Bluetooth connection, a mobile network connection, a universal serial bus (USB) connection, a wireless fidelity (WiFi) connection, and the like, and the embodiments of the present disclosure are not limited in this aspect. In an embodiment of the present disclosure, the server 130 and the terminal device 110 may implement signaling interactions by using a communication connection between the server 130 and the terminal device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Interaction

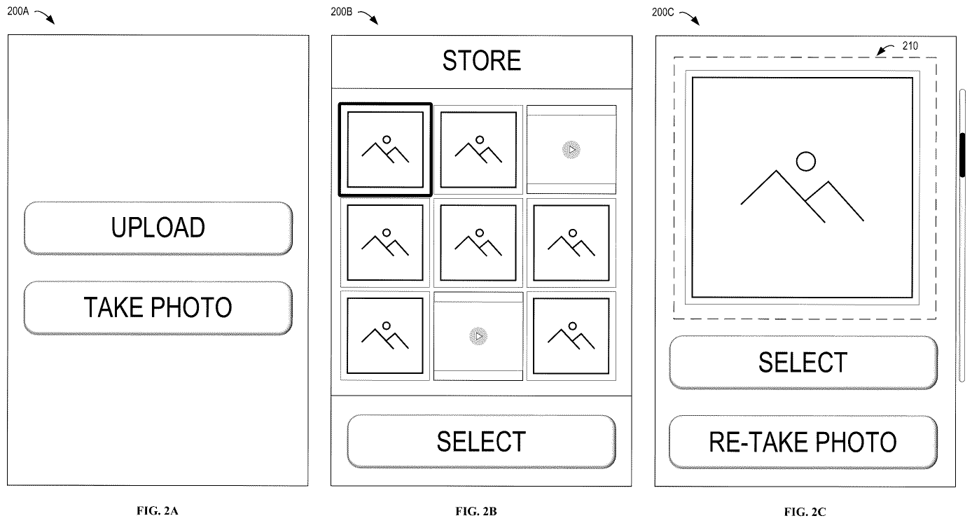

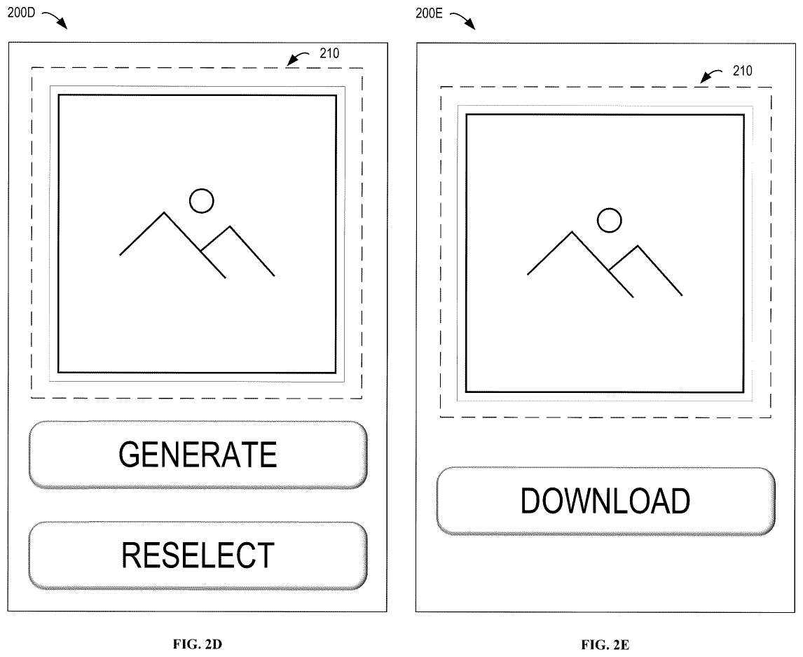

FIG. 2A to FIG. 2E illustrate example interfaces 200A to 200E according to some embodiments of the present disclosure. The interface 200A to the interface 200E may be provided, for example, by the terminal device 110 shown in FIG. 1.

As shown in FIG. 2A, in some embodiments, when receiving the operation information of the user 140 for starting the application 120, the terminal device 110 may present the interface 200A. The interface 200A is used to allow the user 140 to input the first media content.

In some embodiments, the interface 200A may include controls for inputting the first media content. As an example, two controls may be provided. One control is used to upload the first media content stored in the terminal device 110. Another control is used to upload the first media content in a photographing manner. The control for uploading the first media content may present an “upload” typeface. The control for uploading the first media content in a photographing manner may present a “take photo” typeface.

For the “upload” control, when the terminal device 110 receives the operation information of the user 140 on the “upload” control, the terminal device 110 may display an interface 200B shown in FIG. 2B. In some embodiments, the interface 200B may include locally stored data, such as a local album. The interface 200B may further be configured with a control for the user 140 to select an image, so that the terminal device 110 uploads the selected image. As an example, a control for the user 140 to select an image may present a “select” typeface. After receiving the operation information of the user 140 on the “select” control in the interface 200B, the terminal device 110 may upload the image selected by the user 140 in the interface 200B.

For the “take photo” control, when the terminal device 110 receives the operation information of the user 140 on the “take photo” control, the terminal device 110 may invoke the camera function and display the corresponding interface. When the terminal device 110 obtains the shooting result, the terminal device 110 may present the shooting result via the interface 200C shown in FIG. 2C. As shown in FIG. 2C, in some embodiments, the interface 200C may include, but is not limited to, an image preview area 210 indicating a shooting result, a control for uploading a shooting result, and a control for re-shooting, to enable the terminal device 110 obtaining an image by shooting. As an example, a control for uploading a shooting result may present a “select” typeface. The controls for re-shooting may present a “re-take photo” typeface.

In some embodiments, as shown in FIG. 2D, after the terminal device 110 obtains the image selected by the user 140, the interface 200D may be displayed. As an example, the interface 200D may be configured with an image preview area 210 for the user 140 to preview the selected image. In addition, the interface 200D may be further configured with a control indicating the model 440 to apply a corresponding effect, and a control to return to the image selection step. The control that indicates the model 440 to apply the corresponding effect may present a “generate” typeface. The control for returning to the image selection step may present a “reselect” typeface.

In some embodiments, as shown in FIG. 2E, after the terminal device 110 generates the second media content based on the first media content, the terminal device 110 may display, via the interface 200E, information related to the second media content to provide the second media content. As an example, the information related to the second media content may be at least one of a preview image of the second media content or a download link of the second media content.

It should be understood that the media content generation interfaces shown in FIG. 2A to FIG. 2E are merely examples, and other suitable interfaces may be used to generate and provide the second media content. Individual graphical elements in the interface may have different arrangements and different visual representations, one or more of which may be omitted or replaced, and one or more other elements may also be present. Embodiments of the present disclosure are not limited in this respect.

### Example Process

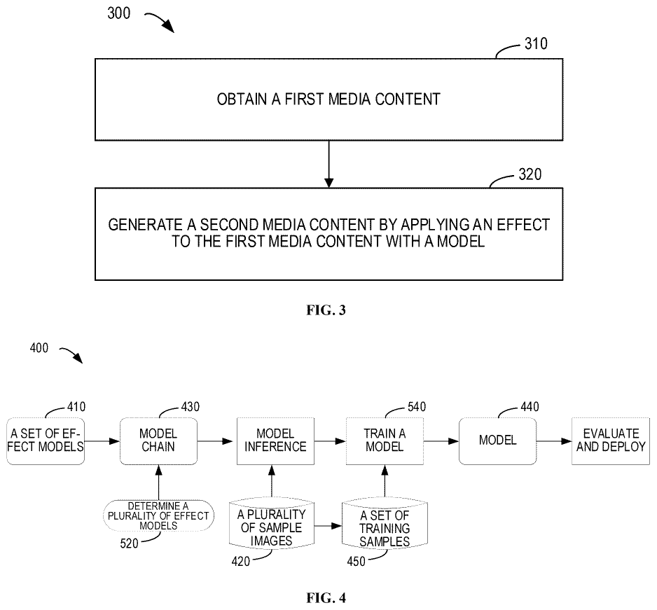

FIG. 3 illustrates a flowchart of an example process 300 of processing the media content according to some embodiments of the present disclosure. The process 300 may be implemented at the terminal device 110. The process 300 is described below with reference to FIG. 1.

As shown in FIG. 3, at block 310, the terminal device 110 obtains a first media content.

In some embodiments, the first media content may be media data obtained by the terminal device 110 from the user 140. The first media content may be presented in other forms such as an image form or a video form. As an example, the first media content may be transmitted to the terminal device 110 by taking photo, wired/wireless transmission, or the like.

At block 320, the terminal device 110 generates a second media content by applying an effect to the first media content with the model 440.

In some embodiments, the second media content is a media content formed after the effect is applied to the first media content. Similar to the presentation form of the first media content, the second media content may be in other presentation form such as an image form or a video form.

In some embodiments, there may be a plurality of types of the model 440 according to the category of the media content to be processed and the category of the effect, examples of which may include, but are not limited to, a model that can process a portrait image, a model that can process a face image, a model that can process a video, and the like.

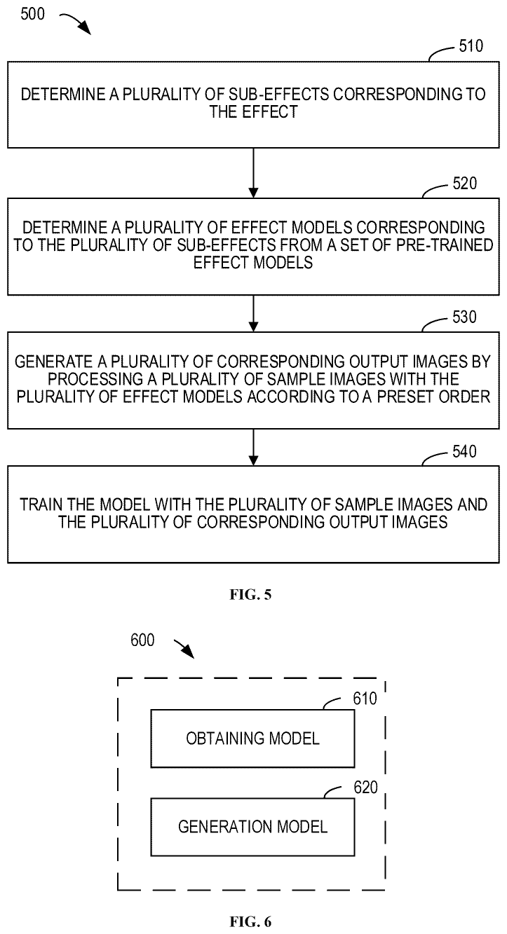

The specific training process of the mode will be further described below with reference to FIG. 4 and FIG. 5. FIG. 4 shows a block diagram of an example process 400 for training a model 440 according to some embodiments of the present disclosure. FIG. 5 illustrates a flowchart of an example process 500 of training a model 440 according to some embodiments of the present disclosure. It should be understood that process 400 and/or process 500 may be performed by an appropriate electronic device, such as server 130. The process 500 will be described below with server 130 as an example.

As shown in FIG. 5, at block 510, the server 130 determines a plurality of sub-effects corresponding to the effect.

In some embodiments, the effect may be classified into a plurality types according to the type of the media content to be processed, or may be classified into a plurality types according to the object to be processed. As an example, the effect may include a variety of cosmetic effects applied to the facial object.

In some embodiments, the plurality of sub-effects may be similar to the effect. The sub-effects may be classified into a plurality types according to the type of media content to be processed, or may be classified into a plurality of types according to the object to be processed. As an example, when the effect includes a plurality of cosmetic effects applied to the facial object, correspondingly, the plurality of sub-effects may include cosmetic effects applied to different parts of the facial object. For example, the effect A includes a cosmetic effect a1 applied to part 1, a cosmetic effect a2 applied to part 2, and a cosmetic effect a3 applied to part 3. The cosmetic effect a1, the cosmetic effect a2 and the cosmetic effect a3 are different sub-effects corresponding to the effect, respectively.

In some embodiments, the server 130 may determine a plurality of sub-effects corresponding to the effect based on the following steps:

First, a plurality of preset objects to be acted on by an effect are determined. In some embodiments, the plurality of preset objects may be different parts of the person, for example, eyes, skin, or the like. As an example, when the effects include cosmetic effects applied to different parts of the facial object, the plurality of preset objects may be different parts in the facial object, for example, eyebrows, eyes, mouth, and the like. Specifically, the server 130 may disassemble the object to be acted on by the effect, thereby determining a plurality of preset objects.

Then, a plurality of sub-effects are determined based on the plurality of preset objects. In some embodiments, each sub-effect may correspond to a subset of the plurality of preset objects. In other words, each sub-effect may act on at least one preset object. The at least one preset object is a subset of the plurality of preset objects to be acted on by the effect. Taking the plurality of preset objects to be acted on by the effect as different parts of the facial object as an example, the sub-effect may be a cosmetic effect acting on the eyes, and the sub-effect may also be a cosmetic effect acting on the eyes and eyebrows. As an example, when determining the plurality of sub-effects based on the plurality of preset objects, the server 130 may determine the plurality of sub-effects based on a common matching manner of the plurality of preset objects to be acted on by the cosmetic effect. For example, if the cosmetic effect a, the cosmetic effect b and the cosmetic effect c act on the eyes and the eyelashes, the server 130 may take the cosmetic effect acting on the eyes and eyelashes in the effect as one of the sub-effects.

At block 520, the server 130 determines a plurality of effect models corresponding to the plurality of sub-effects from a set of pre-trained effect models 410.

In some embodiments, the set of pre-trained effect models 410 may include a plurality of pre-trained effect models. The plurality of effect models has a plurality of cosmetic effects, and various cosmetic effects may be applied to the input image of the effect model to decorate the input image. As an example, the effect model in the set of pre-trained effect models 410 may act on different parts of the facial object.

In some embodiments, the server 130 may determine a plurality of effect models corresponding to the plurality of sub-effects based on the following steps:

First, at least one candidate effect model corresponding to a sub-effect among a plurality of sub-effects is determined from the set of effect models 410. In some embodiments, when determining at least one candidate effect model, the at least one candidate effect model is determined corresponding to each selected sub-effect by selecting one by one of the at least one candidate effect model from the plurality of sub-effects. The above selected sub-effect is the sub-effect.

After the sub-effect is determined, the at least one candidate effect model corresponding to the sub-effect is determined as an example for detailed description.

In some embodiments, after determining the sub-effect, the server 130 may determine at least one preset object to be acted on by the sub-effect. Based on the at least one preset object, the server 130 may determine all effect models acting on the at least one preset object in the set of effect models 410 as alternative effect models. Then, the server 130 may filter the plurality of candidate effect models to obtain at least one candidate effect model corresponding to the sub-effect. As an example, the server 130 may filter based on the degree of deviation between the cosmetic effect of the alternative effect model and the sub-effect. The degree of deviation here includes, but is not limited to, the deviation of the hue of the cosmetic effect. For example, the sub-effect is the cosmetic effect of the warm hue, and at this time, the server 130 may determine, from all the candidate effect models, at least one candidate effect model whose cosmetic effect is the warm hue effect, as the candidate effect model.

After determining the at least one candidate effect model corresponding to the sub-effect, the server 130 may determine, in response to the number of the at least one candidate effect model being greater than a threshold, an effect model corresponding to the sub-effect from the at least one candidate effect model based on model evaluation information of the at least one candidate effect model.

In some embodiments, when the number of the at least one candidate effect model corresponding to the sub-effect is greater than the threshold, it indicates that a large number of candidate effect models are available, and the server 130 needs to determine the effect model therefrom. On the contrary, when the number of the at least one candidate effect model corresponding to the sub-effect is less than or equal to the threshold, it indicates that a small number of candidate effect models are available, and the at least one candidate effect model is the effect model. As an example, the threshold may be set to 1.

For the case that the number of the at least one candidate effect model is greater than the threshold, the server 130 may first determine the model evaluation information of each candidate effect model, and then determine the effect model based on the model evaluation information of the at least one candidate effect model. In some embodiments, the model evaluation information may indicate a quality of each effect model in the set of effect models 410. As an example, the model evaluation information may be obtained based on model information related to the effect model, and may be presented in a score manner.

In some embodiments, the model information may include, but is not limited to, a number of times that an effect model is used by the user 140. There is a plurality of manners in which the server 130 determines the model evaluation information of each candidate effect model with the model information. For example, the server 130 may determine the number of times that each effect model is used by the user 140. The server 130 then determines a maximum of the number of times that the effect model is used by the user 140. The server 130 determines the model evaluation information of the effect model based on the ratio of the number of times that the effect model is used by the user 140 to the maximum value. Based on this, the server 130 may determine the model evaluation information of each candidate effect model. In addition, in some embodiments, the number of times that the effect model is used by the user 140 may also be directly used as the model evaluation information.

In some embodiments, the effect model may also be used as a basis for other effect models. For ease of description, the effect model used as the basis of the other effect model is referred to as a reference effect model. Based on this, for the reference effect model, the number of times that it is used by the user 140 may include the number of times that the reference effect model is used by the user 140 and the number of times that the effect model derived from the reference effect model is used by the user 140. Thus, the server 130 may set the corresponding weights to determine the model evaluation information of each effect model. As an example, the server 130 may determine a first score and a second score of each effect model respectively in the foregoing manner. The first score is a ratio of the number of times that the effect model is used by the user 140 to a maximum value of the number of times that the effect model is used by the user 140. The second score is a ratio of the number of times that the effect model derived from the effect model is used by the user 140 to the corresponding maximum value. When the effect model is not the reference effect model, the second score of the effect model may be 0. The server 130 may determine the model evaluation information of each effect model based on a product of the first score and a corresponding weight and a product of the second score and a corresponding weight. Based on this, the server 130 may determine the model evaluation information of each candidate effect model. In addition, in some embodiments, the model evaluation information of each effect model may also be determined directly based on the number of times that the effect model derived from the reference effect model is used by the user 140.

In some embodiments, after determining the model evaluation information of the at least one candidate effect model, the server 130 may determine a candidate effect model of which the model evaluation information is the best to serve as the effect model. As an example, the candidate effect model with the best model evaluation information is the candidate effect model with the highest score reflected by the model evaluation information.

In the foregoing manner, the server 130 may sequentially determine an effect model corresponding to each sub-effect, that is, may determine a plurality of effect models corresponding to the plurality of sub-effects.

At block 530, the server 130 generates a plurality of corresponding output images by processing the plurality of sample images 420 with the plurality of effect models according to a preset order.

In some embodiments, the sample image 420 may be a plurality of sample images 420 satisfying a preset constraint determined from a set of sample images 420, where the preset constraint may indicate that the sample images 420 include a plurality of preset objects. In other words, the sample images 420 are all sample images 420 including a plurality of preset objects in the set of sample images 420. The plurality of preset objects herein are a plurality of preset objects to be acted on by the effect. As an example, the set of sample images 420 may include a real image (FFHQ dataset) and a composite image (FFHQ dataset).

In some embodiments, the server 130 may generate a plurality of corresponding output images based on the following steps:

First, the server 130 may combine the plurality of effect models into a model chain 430 according to a preset order. In some embodiments, taking two adjacent effect models in the preset order as an example, the process in which the server 130 combines the plurality of effect models into the model chain 430 is: connecting an output end of the first effect model to an input end of a second effect model in the model chain, in which the first effect model may be an effect model sequentially preceding in two adjacent effect models, and the second effect model may be an effect model sequentially following in two adjacent effect models. In the foregoing manner, the server 130 may combine the plurality of effect models into the model chain 430.

In some embodiments, the preset order may be determined according to an association relationship between a plurality of preset objects to be acted by effects of the plurality of effect models. For example, an effect of the effect model A acts on the preset object a1 and the preset object a2. An effect of the effect model B acts on the preset object b. An effect of the effect model C acts on the preset object c1 and the preset object c2. Through multiple attempts, it is observed that, when the preset object b in the sample image 420 is first processed, then the preset object a1 and the preset object a2 are processed, and finally the preset object c1 and the preset object c2 are processed, the processed sample image 420 can obtain the best effect. Therefore, the preset order may be the effect model B-the effect model A-the effect model C.

The server 130 may then generate a plurality of output images by processing the plurality of sample images 420 with the model chain 430.

In some embodiments, the process of the server 130 processing the plurality of sample images 420 with the model chain 430 may be: the server 130 inputs one sample image 420 into the model chain 430, and the sample image 420 is processed by the first effect model in the model chain 430 to obtain a first intermediate image. The first intermediate image is then processed by a second effect model in the model chain 430 to obtain a second intermediate image. Then, the second intermediate image is processed by the third effect model in the model chain 430 to obtain the third intermediate image. By analogy, the (N−1)-th intermediate image is finally processed by the N-th effect model in the model chain 430, that is, the last effect model, to obtain an output image, where N is an integer greater than 1. Through the above processing process, the server 130 may generate a plurality of output images corresponding to the plurality of sample images 420.

In some embodiments, the generated plurality of output images corresponding to the plurality of sample images 420 may indicate a cosmetic effect of the model chain 430. When the cosmetic effect of the model chain 430 differs largely from the effect of the model 440, the server 130 may adjust the model chain 430. As an example, the server 130 may perform adjustments by redetermining the plurality of effect models corresponding to the plurality of sub-effects or adjust the preset order.

In some embodiments, the manner in which the server 130 redetermines the plurality of effect models corresponding to the plurality of sub-effects may be: first determining an effect model that needs to be adjusted and then redetermining the effect model from the corresponding at least one candidate effect model based on a sub-effect corresponding to the effect model that needs to be adjusted. As an example, when redetermining the effect model, the server 130 may determine the effect model in descending order of scores indicated by the model evaluation information.

In some embodiments, the manner in which the server 130 adjusts the preset order may be: first adjusting the preset sequence, and then recombining the plurality of effect models into the model chain 430 according to the adjusted preset order. When the cosmetic effect of the model chain 430 reflected by the output image is still different from the effect, the server 130 may adjust the preset order again. As an example, the server 130 may only adjust a position of one effect model in the preset order each time when adjusting the preset order, and only adjust the position of the effect model by one step forward or backward in the preset order at a time.

In some embodiments, in order to reduce the cost of adjusting the cosmetic effect of the model chain 430 to the effect of the model 440, before generating the plurality of output images by processing the plurality of sample images 420 with the model chain 430, the server 130 may first input at least one sample image 420 of the plurality of sample images 420 into the model chain 430 to generate at least one reference image corresponding to the at least one sample image 420. Then, the server 130 determines, based on the at least one sample image 420 and the at least one reference image, whether the model chain 430 needs to be adjusted, and adjusts in the foregoing manner if the adjustment is required.

In some embodiments, in response to a deviation between the at least one reference image and the at least one corresponding sample image 420, the server 130 may adjust the model chain 430. Specifically, the server 130 may obtain the deviation between the at least one reference image and the at least one corresponding sample image 420 with an image difference method, that is, a subtraction result. The subtraction result may indicate a cosmetic effect corresponding to the plurality of preset objects. Further, the server 130 may determine at least one cosmetic effect which does not match the other cosmetic effects in the subtraction result. Through at least one non-matching cosmetic effect, the server 130 may determine a plurality of preset objects corresponding to the at least one non-matching cosmetic effect, and further determine an effect model that needs to be adjusted. In adjusting the model chain 430, the server 130 may adjust in the manner described above.

In some embodiments, when the server 130 determines that there is no non-matching cosmetic effect in the subtraction result, it indicates that the cosmetic effect of the model chain 430 is relatively matched with the effect of the model 440. At this time, the server 130 may generate a plurality of corresponding output images by processing the plurality of sample images 420 with the model chain 430.

At block 540, the server 130 trains a model 440 with the plurality of sample images 420 and the plurality of corresponding output images.

In some embodiments, the server 130 may train the model 440 based on the following steps: first, the server 130 constructs a plurality of training image pairs with the plurality of sample images 420 and the plurality of corresponding output images. Then, the server 130 constructs a set of training samples 450 based on the plurality of training image pairs. Finally, the server 130 trains the model 440 with the set of training samples 450.

In some embodiments, the server 130 may determine a set of training image pairs for constructing the set of training samples 450 by filtering the plurality of training image pairs. As an example, the server 130 may determine, from the plurality of training image pairs, a group of training image pairs of which image evaluation information satisfies a preset condition based on the image evaluation information of the plurality of training image pairs.

In some embodiments, the image evaluation information of the training image pair may be obtained by the subtraction result between the output image and the sample image 420 in the training image pair determined by the server 130. As an example, the server 130 may determine a subtraction result for each training image pair based on the output image and the sample image 420 of each training image pair. Since the cosmetic effect of the model chain 430 is affected by the sample image 420, there may be a difference between the subtraction results of different training image pairs. The larger the difference, the better the cosmetic effect is. Based on this, the subtraction results of the plurality of training image pairs are classified, so that the image evaluation information of each training image pair can be obtained. The classification result of the subtraction result of the training image pair may indicate the quality level of the training image pair. The image evaluation information is the quality level of the training image pair. The process of classifying the subtraction results of the plurality of training image pairs may be implemented by the server 130 or manually.

In some embodiments, the preset condition related to the image evaluation information may be that a quality level indicated by the image evaluation information reaches a preset level. When the quality level indicated by the image evaluation information reaches a preset level, it indicates that the quality of the training sample pair is good, and may be used as a training sample. On the contrary, when the quality level indicated by the image evaluation information does not reach the preset level, it indicates that the quality of the training sample pair is general, which cannot be used as a training sample. Based on this, the server 130 may obtain a set of training image pairs with good quality to construct the set of training samples 450.

Based on the process described above, embodiments of the present disclosure construct the set of training samples 450 with the model chain 430 combined with a plurality of effect models associated with the effect to train the model 440, and embodiments of the present disclosure can reduce human resources required for training the model 440, and improve the generation efficiency of the model 440 to some extent.

### Example Apparatus and Device

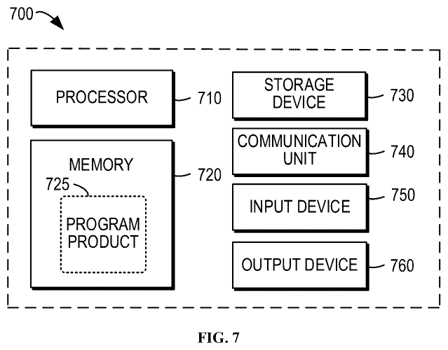

Embodiments of the present disclosure also provide a corresponding apparatus for implementing the above method or process. FIG. 6 shows a schematic structural block diagram of an example apparatus 600 for processing a media content according to some embodiments of the present disclosure. The apparatus 400 may be implemented or included in the terminal device 110. The various modules/components in the apparatus 600 may be implemented by hardware, software, firmware, or any combination thereof.

As shown in FIG. 6, the apparatus 600 includes: an obtaining module 610 configured to obtain a first media content; and a generation module 620 configured to generate a second media content by applying an effect to the first media content with a model, where the model is trained based on the following process: determining a plurality of sub-effects corresponding to the effect; determining a plurality of effect models corresponding to the plurality of sub-effects from a set of pre-trained effect model; generating a plurality of corresponding output images by processing a plurality of sample images with the plurality of effect models according to a preset order; and training the model with the plurality of sample images and the plurality of corresponding output images.

In some embodiments, determining the plurality of sub-effects corresponding to the effect includes: determining a plurality of preset objects to be acted on by the effect; and determining a plurality of sub-effects based on the plurality of preset objects, where each sub-effect corresponds to a subset of the plurality of preset objects.

In some embodiments, the plurality of sample images are determined based on the following process: determining a plurality of sample images satisfying a preset constraint from the set of sample image, the preset constraint indicates that each sample image includes a plurality of preset objects.

In some embodiments, determining the plurality of effect models corresponding to the plurality of sub-effects from the set of pre-trained effect models includes: determining, from the set of effect models, at least one candidate effect model corresponding to the sub-effect among the plurality of sub-effects; and in response to the number of the at least one candidate effect model being greater than a threshold, determining an effect model corresponding to the sub-effect from the at least one candidate effect model based on model evaluation information of the at least one candidate effect model.

In some embodiments, generating the plurality of corresponding output images by processing the plurality of sample images with the plurality of effect models according to the preset order includes: combining the plurality of effect models into a model chain according to a preset order, where an output end of the first effect model in the model chain is connected to an input end of a second effect model in the model chain; and generating a plurality of output images by processing the plurality of sample images with the model chain.

In some embodiments, training the model with the plurality of sample images and the plurality of corresponding output images includes: constructing a plurality of training image pairs with the plurality of sample images and the plurality of corresponding output images; constructing a set of training samples based on the plurality of training image pairs; and training the model with the set of training samples.

In some embodiments, constructing the set of training samples based on the plurality of training image pairs includes: determining, from the plurality of training image pairs, a set of training image pairs of which image evaluation information satisfies a preset condition based on the image evaluation information of the plurality of training image pairs; and constructing a set of training samples based on the set of training image pairs.

In some embodiments, the effect includes a plurality of cosmetic effects applied to the facial object, and the plurality of sub-effects includes cosmetic effects applied to different parts of the facial object.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor systems, multiple processing units execute computer-executable instructions in parallel to improve parallel processing capabilities of the electronic device 700.

The electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combinations thereof. The storage device 730 may be a removable or non-removable medium and may include a machine-readable medium, such as a flash drive, magnetic disk, or any other medium, which may be capable of storing information and/or data and may be accessed within the electronic device 700.

The electronic device 700 may further include additional removable/non-removable, volatile/non-volatile storage media. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 communicates with other electronic device through a communication medium. Additionally, the functionality of components of the electronic device 700 may be implemented in a single computing cluster or multiple computing machines capable of communicating over a communication connection. Thus, the electronic device 700 may operate in a networked environment using logical connections with one or more other servers, network personal computers (PCs), or another network node.

The input device 750 may be one or more input devices, such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed, external devices such as storage devices, display devices and so on, communicate with one or more devices that enable a user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to example implementations of the present disclosure, there is provided a computer-readable storage medium having computer-executable instructions stored thereon, in which the computer-executable instructions are executed by a processor to implement the method described above. According to example implementations of the present disclosure, a computer program product is further provided, the computer program product is tangibly stored on a non-transitory computer-readable medium and includes computer-executable instructions, which is executed by a processor to implement the method described above.

Aspects of the present disclosure are described herein with reference to flowcharts and/or block diagrams of methods, apparatuses, devices, and computer program products implemented according to the present disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general-purpose computer, special purpose computer, or other programmable data processing apparatus to produce a machine, such that the instructions, when executed by a processing unit of a computer or other programmable data processing apparatus, produce means to implement the functions or actions specified in one or more blocks of the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions or actions specified in one or more blocks of the flowchart and/or block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions or actions specified in one or more blocks of the flowchart and/or block diagram.

The flowchart and block diagrams in the accompanying drawings show architecture, functionality, and operation of possible implementations of systems, methods, and computer program products according to various implementations of the present disclosure. In this regard, each block in the flowchart or block diagram may represent a module, program segment, or a portion of an instruction that includes one or more executable instructions for implementing the specified logical function. In some alternative implementations, the functions noted in the blocks may also occur in a different order than noted in the accompanying drawings. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are examples, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method for processing a media content comprising:
obtaining a first media content; and
generating a second media content by applying an effect to the first media content with a model,
wherein the model is trained based on the following process: determining a plurality of sub-effects corresponding to the effect; determining a plurality of effect models corresponding to the plurality of sub-effects from a set of pre-trained effect models; generating a plurality of corresponding output images by processing a plurality of sample images with the plurality of effect models according to a preset order; and training the model with the plurality of sample images and the plurality of corresponding output images.

2. The method of claim 1, wherein determining the plurality of sub-effects corresponding to the effect comprises:
determining a plurality of preset objects to be acted on by the effect; and
determining the plurality of sub-effects based on the plurality of preset objects, wherein each sub-effect corresponds to a subset of the plurality of preset objects.

3. The method of claim 2, wherein the plurality of sample images are determined based on:
determining the plurality of sample images meeting a preset constraint from a set of sample images, wherein the preset constraint indicates that each sample image comprises the plurality of preset objects.

4. The method of claim 1, wherein determining the plurality of effect models corresponding to the plurality of sub-effects from the set of pre-trained effect models comprises:
determining, from the set of effect models, at least one candidate effect model corresponding to a sub-effect among the plurality of sub-effects; and
determining, in response to the number of the at least one candidate effect model being greater than a threshold, an effect model corresponding to the sub-effect from the at least one candidate effect model based on model evaluation information of the at least one candidate effect model.

5. The method of claim 1, wherein generating the plurality of corresponding output images by processing the plurality of sample images with the plurality of effect models according to the preset order comprises:
combining the plurality of effect models into a model chain according to the preset order, wherein an output end of a first effect model in the model chain is connected to an input end of a second effect model in the model chain; and
generating the plurality of output images by processing the plurality of sample images with the model chain.

6. The method of claim 1, wherein training the model with the plurality of sample images and the plurality of corresponding output images comprises:
constructing a plurality of training image pairs with the plurality of sample images and the plurality of corresponding output images;
constructing a set of training samples based on the plurality of training image pairs; and
training the model with the set of training samples.

7. The method of claim 6, wherein constructing the set of training samples based on the plurality of training image pairs comprises:
determining, from the plurality of training image pairs, a set of training image pairs of which image evaluation information satisfies a preset condition based on the image evaluation information of the plurality of training image pairs; and
constructing the set of training samples based on the set of training image pairs.

8. The method of claim 1, wherein the effect comprises a plurality of cosmetic effects applied to a facial object, and the plurality of sub-effects comprises cosmetic effects applied to different parts of the facial object.

9. An electronic device comprising:
at least one processor; and
at least one memory coupled to the at least one processor and storing instructions for execution by the at least one processor, the instructions, when executed by the at least one processing unit, causing the electronic device to perform acts comprising:
obtaining a first media content; and
generating a second media content by applying an effect to the first media content with a model,
wherein the model is trained based on the following process: determining a plurality of sub-effects corresponding to the effect; determining a plurality of effect models corresponding to the plurality of sub-effects from a set of pre-trained effect models; generating a plurality of corresponding output images by processing a plurality of sample images with the plurality of effect models according to a preset order; and training the model with the plurality of sample images and the plurality of corresponding output images.

10. The electronic device of claim 9, wherein determining the plurality of sub-effects corresponding to the effect comprises:
determining a plurality of preset objects to be acted on by the effect; and
determining the plurality of sub-effects based on the plurality of preset objects, wherein each sub-effect corresponds to a subset of the plurality of preset objects.

11. The electronic device of claim 10, wherein the plurality of sample images are determined based on:
determining the plurality of sample images meeting a preset constraint from a set of sample images, wherein the preset constraint indicates that each sample image comprises the plurality of preset objects.

12. The electronic device of claim 9, wherein determining the plurality of effect models corresponding to the plurality of sub-effects from the set of pre-trained effect models comprises:
determining, from the set of effect models, at least one candidate effect model corresponding to a sub-effect in the plurality of sub-effects; and
determining, in response to the number of the at least one candidate effect model being greater than a threshold, an effect model corresponding to the sub-effect from the at least one candidate effect model based on model evaluation information of the at least one candidate effect model.

13. The electronic device of claim 9, wherein generating the plurality of corresponding output images by processing the plurality of sample images with the plurality of effect models according to the preset order comprises:
combining the plurality of effect models into a model chain according to the preset order, wherein an output end of a first effect model in the model chain is connected to an input end of a second effect model in the model chain; and
generating the plurality of output images by processing the plurality of sample images with the model chain.

14. The electronic device of claim 9, wherein training the model with the plurality of sample images and the plurality of corresponding output images comprises:
constructing a plurality of training image pairs with the plurality of sample images and the plurality of corresponding output images;
constructing a set of training samples based on the plurality of training image pairs; and
training the model with the set of training samples.

15. The electronic device of claim 14, wherein constructing the set of training samples based on the plurality of training image pairs comprises:
determining, from the plurality of training image pairs, a set of training image pairs of which image evaluation information satisfies a preset condition based on the image evaluation information of the plurality of training image pairs; and
constructing the set of training samples based on the set of training image pairs.

16. The electronic device of claim 9, wherein the effect comprises a plurality of cosmetic effects applied to a facial object, and the plurality of sub-effects comprises cosmetic effects applied to different parts of the facial object.

17. A non-transitory computer-readable storage medium having stored thereon a computer program executable by a processor to implement acts comprising:
obtaining a first media content; and
generating a second media content by applying an effect to the first media content with a model,
wherein the model is trained based on the following process: determining a plurality of sub-effects corresponding to the effect; determining a plurality of effect models corresponding to the plurality of sub-effects from a set of pre-trained effect models; generating a plurality of corresponding output images by processing a plurality of sample images with the plurality of effect models according to a preset order; and training the model with the plurality of sample images and the plurality of corresponding output images.

18. The non-transitory computer-readable storage medium of claim 17, wherein determining the plurality of sub-effects corresponding to the effect comprises:
determining a plurality of preset objects to be acted on by the effect; and
determining the plurality of sub-effects based on the plurality of preset objects, wherein each sub-effect corresponds to a subset of the plurality of preset objects.

19. The non-transitory computer-readable storage medium of claim 18, wherein the plurality of sample images are determined based on:
determining the plurality of sample images meeting a preset constraint from a set of sample images, wherein the preset constraint indicates that each sample image comprises the plurality of preset objects.

20. The non-transitory computer-readable storage medium of claim 17, wherein determining the plurality of effect models corresponding to the plurality of sub-effects from the set of pre-trained effect models comprises:
determining, from the set of effect models, at least one candidate effect model corresponding to a sub-effect in the plurality of sub-effects; and
determining, in response to the number of the at least one candidate effect model being greater than a threshold, an effect model corresponding to the sub-effect from the at least one candidate effect model based on model evaluation information of the at least one candidate effect model.
